(19) United States
(12) Patent Application Publication
(10) Pub. No.: US 2005/0116813 A1
(43) Pub. Date: Jun. 2, 2005

(54) Radio and optical identification tags

(76) Inventor: Ramesh Raskar, Cambridge, MA (US)

Correspondence Address: Patent Department;Mitsubishi Electric Research Laboratories, Inc., 201 Broadway, Cambrige, MA, 02139, US

(21) Appl. No.: 11/030,607

(22) Filed: Jan. 6, 2005

Related U.S. Application Data
(63) Continuation-in-part of application No. 10/643,614, filed on Aug. 19, 2003.

(51) Int. Cl. H04Q 5/22

(52) U.S. Cl. 340/10.1; 235/492; 340/10.5

(57) ABSTRACT

An identification tag is formed with a single microcircuit. The microcircuit includes an optical transceiver, a radio transceiver, both connected to a memory storing an identification code. At least one of the transceivers operates in receive mode, and at least one of the transceivers operates in transmit mode. The identification code is transmitted by the transceiver operating in the transmit mode in response to receiving a predetermined signal by the transceiver operating in the receive mode.

### RELATED APPLICATION

This Patent Application is a Continuation-in-Part of U.S. patent application Ser. No. 10/643,614 filed on Aug. 19, 2003.

### FIELD OF THE INVENTION

This invention relates generally to identification tags, and more particularly to tags that can be selectively operated.

### BACKGROUND OF THE INVENTION

Conventional radio-frequency identification (RFID) tags are used to identify objects, including people. RFID tags provide an alternative to bar codes for distinguishing and recording products for purchase. Using RFID tags can result in labor savings to manufacturers, distributors, and retailers. Annual estimated savings for a large retailer using RFID tags could amount to billions of dollars.

The typical prior art RFID tag includes a microchip and an antenna. The antenna can be in the form of a tuned induction coil. The operation is fundamentally simple. Typically, the microchip stores a unique identification code that can be detected when the antenna of the tag couples inductively with an antenna of the reader. This coupling changes the impedance, hence the load at the receiving antenna. The load can be modulated according to the stored identification code by switching the coil in and out.

Conventional RFID tags can be characterized according to the following basic attributes. An active RFID tag includes a power source to operate the microchip and to ‘broadcast’ the signal to the reader. Semi-passive tags use a battery to operate the microchip, but use an induced current to operate the transmitter. Because these types of tags are more costly to manufacture, they are typically used for high-cost objects that need to be identified at greater distances. For a passive tag, the reader induces a current in the tag by emitting electromagnetic radiation. These tags are relatively cheap, and are effective up to ranges of about 50 meters, depending on the power of the transmitted RF signal.

The tag can be read-only or read-and-write. In the latter type, information can be added to the tag over time using, e.g., an electrically erasable programmable read-only memory (EEPROM). For example, the tag can store when it was read, or how often it was read.

RFID tags can also be distinguished according to the frequency at which they operate. The operating frequencies need to be consistent with RF spectrum assignments made by regulatory agencies such as the FCC in the United States. Low frequency tags are generally cheaper to make than high frequency devices and use less power. Different applications may also prefer different frequencies. For example, low frequency tags are more suitable for applications with a high fluid content, e.g., items under water, humans, fruits, water based products. High frequency tags provide a higher data rate and range. Also, because high frequencies tend to be line-of-sight, they can be useful at fixed locations with a narrow field-of-view, for example, in assembly lines and doorways.

One problem encountered with RFID tags is collision.

Reader collision can happen when one reader interferes with the signal of another nearby reader. This can be a problem in warehousing where multiple users may want to identify stock at the same time. This can result in multiple readings of the same tag, which need to be resolved. In the prior art, time division multiplexing has been used to overcome this problem. However, this increases the complexity and cost of the system.

Tag collision also occurs when many tags are co-located. This can result in multiple simultaneous readings of different tags, which need to be resolved. A number of techniques have been proposed to mitigate such collisions. Most of these require complex protocols that slow down the process.

Therefore, there is a need for RFID tags that can be selectively operated.

### SUMMARY OF THE INVENTION

An identification tag is formed with a single microcircuit. The microcircuit includes an optical transceiver in the form of a single photodiode or phototransistor. The diode can transmit and sense light depending on the direction current is driven through the diode.

The circuit also includes a radio transceiver. In its simplest form the transceiver is an induction coil. Both the optical and radio transceivers are connected to a memory storing an identification code.

At least one of the transceivers operates in receive mode, and at least one of the transceivers operates in transmit mode. The identification code is transmitted by the transceiver operating in the transmit mode in response to receiving a predetermined signal by the transceiver operating in the receive mode.

### BRIEF DESCRIPTION OF THE DRAWINGS

FIG. 1 is a block diagram of an identification tag according to the invention;

FIG. 2 is a top view of the tag of FIG. 1 to scale;

FIG. 3 is a block diagram of an RFID system including an identification tag and reader according to the invention;

FIG. 4 is a detailed block diagram of the identification tag according to the invention;

FIG. 5 is a detailed block diagram of a reader according to the invention;

FIG. 6 a flow diagram of the RFID system operation;

FIG. 7 a flow diagram of the initialization steps;

FIG. 8 is a flow diagram of a read ID command;

FIG. 9 is a block diagram of an alternative embodiment of the RFID tag according to the invention;

FIG. 10 is a block diagram of an alternative embodiment of the reader according to the invention;

FIG. 11 is a block diagram of an alternative embodiment of a reader;

FIG. 12 is a block diagram of an alternative embodiment of a RFID tag;

FIG. 13 is a block diagram of an alternative embodiment of a tag reader; and

FIGS. 14-18 are flow diagrams of operations of the RFID tag and reader according to the invention.

### DETAILED DESCRIPTION OF THE PREFERRED EMBODIMENT

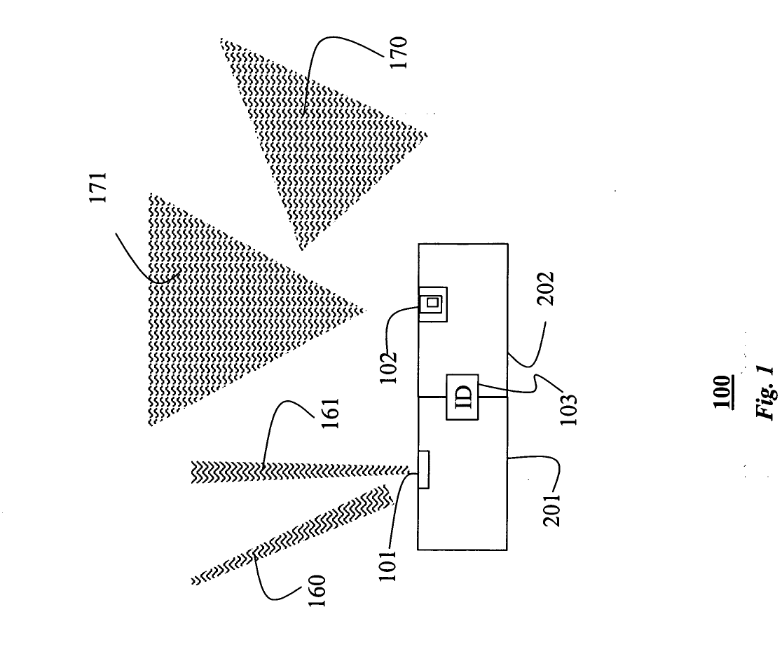

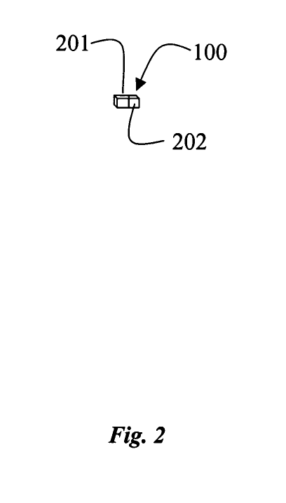

FIGS. 1 and 2 show an identification tag 100 according to the invention. The tag is formed on a single integrated microcircuit a few millimeters in length on each side. The tag is comparable to RFID tags as known in the art. The primary purpose of the tag is to provide identification to users. In addition, the tag according to the invention also provides for visual identification.

The tag 100 includes an optical-frequency (OF) transceiver 201 and a radio-frequency (RF) transceiver 202. The OF transceiver uses a single frequency band (optical channel) to receive and transmit signals. The RF transceiver uses another single frequency band (RF channel) to transmit and receive signals.

The OF transceiver 201 includes a photodiode or phototransistor 101 that is capable of receiving light 160 and transmitting light 161 in a specific frequency band. U.S. patent application Ser. No. 10/126,761, “Communication Using Bi-Directional LEDs,” filed by Dietz et al. on Apr. 19, 2002 and incorporated herein by reference in its entirety, describes such a photo transceiver. Alternatively, the OF transceiver can be a phototransistor. The OF transceiver can be used to acquire synchronization information to support communications with tag readers. The OF transceiver can be configured to be narrow beam or omni-directional.

The RF transceiver 202 includes an antenna 102 that can receive radio signals 170 and transmit radio signals 171. By ‘transmitting,’ it is meant that the RF antenna 102 can selectively couple to another antenna by a radio frequency signal. That is, the antenna is in the form of an induction coil. The current induced in the coil can also be used to power the OF and RF transceivers parasitically. The current can be stored in a capacitor.

Both transceivers 201-202 have access to a memory 103 storing an identification (ID) code. The code can include other information, such as a manufacturing date or an expiration date. The ID code can be unique or belong to a class of codes.

During operation, at least one of the transceivers operates in a receive mode and at least one transceiver operates in a transmit mode. The receiving and transmitting transceivers can be the same or different. The ‘receiving’ transceiver, upon detecting a received signal on its associated channel, e.g., either the optical signal 160 or the RF signal 170, causes the ‘transmitting’ transceiver to respond with a transmitted signal, e.g., either the RF signal 171 or the optical signal 161. The transmitted signal is modulated according to the ID code 103, or some other stored information. It should be understood that the tag can also have both the transceivers operate in both modes concurrently. For example, if the ID code corresponds to a particular product class, and multiple products of that class are within range, only products with an expired date can respond.

Modes of Operation

Light-In/RF-Out

A user shines a narrow beam of predetermined signal light 160 at the tag 100. The tag, in response to receiving the predetermined signal, transmits the ID in the RF signal 171. This allows the user to select a specific tag for identification. For example, the user can identify a box at a hard to reach location. The RF transceiver is said to be transmitting when the RF antenna is selectively coupled to a sensing device to convey, e.g., the ID code 103.

RF-In/Light-Out

A user transmits a query in the form of the predetermined radio signal 170 to an area including one or more tags. The tag then emits light 161 if the received signal matches the ID 103. This allows the user to visually identify a specific tag. This is useful to pick out a specific box mingled among other identical boxes. The light can be steady or modulated according to the code 103.

Light-In/Light and RF-Out

A user shines a narrow beam of predetermined signal light 160 at the tag 100. The tag responds the ID in the RF signal 171 if the predetermined signal 160 is sensed. In addition, the tag transmits light 161 if the RF query signal matches the ID 103. This allows the user to select a specific tag for identification and to visually locate the tag.

RF-In/Light and RF-Out

A user transmits a query in the form of the predetermined radio signal 170 to an area including one or more tags. The tag then emits light 161 if the query matches the ID 103. In addition, the tag emits the RF signal 171 if the query matches the ID 103. This allows the user to visually identify a specific tag, and obtain its identification.

Light and RF-In//Light and RF-Out

In this case, the tag will respond with a light and an RF signal only if both a light and a RF signal are received.

The mode of operation can be predetermined, can be encoded in the tag, or can be selected dynamically by modulating the received signal appropriately.

The tag according to the invention solves the collision problem as described above. In addition, the tag allows for visual identification in applications where a large number of tags are co-located.

It should be understood that the tag can be enhanced to include means for storing power to increase the range of the transceivers. The transceivers can be operated parasitically from power obtained from the RF signal.

The tag can perform additional processing to store received data and to operate in accordance with the stored data.

RFID System

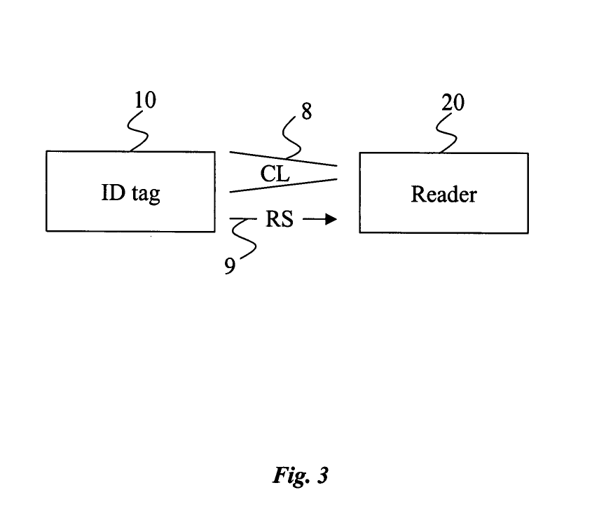

FIG. 3 shows a RFID system including a tag 10 and a RFID reader 20. The tag transmits information from the tag 10, e.g., an ID, to the reader 20 as a response signal (RS) 9 when detecting a predetermined signal, e.g., a command light (CL) 8 emitted by the reader 20 and directed onto the tag 10. Hence, the reader 20 obtains the ID of the tag, and other information as described above.

The reader 20 is usually operated by the user and the tag 10 is usually attached to a product, pallet, case, or other packing materials. The emitted light can be passed through a lens to control a range and shape of the light beam. Alternatively, the light beam can be shaped by a pixel-based digital projector. Thus, the command light can be directed at a single tag or a predetermined number of adjacent tags. The light beam indicates that the tag is being read so that other users do not accidentally also attempt to read the tag at the same time.

TAG Structure

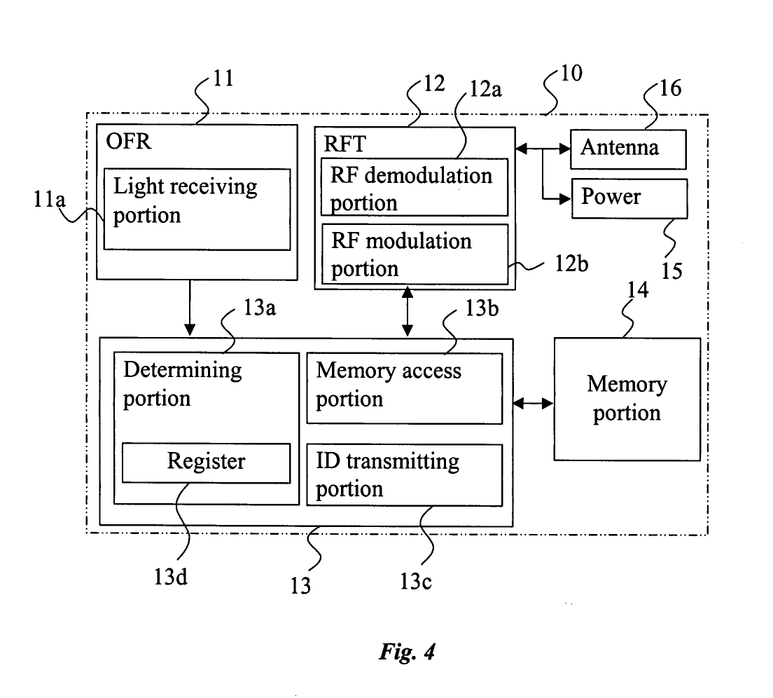

FIG. 4 shows the details of the identification tag 10. The ID tag 10 is passive. Electric power is supplied by electromagnetic waves radiated from the reader 20. The ID tag 10 includes an optical frequency receiver (OFR) 11, a radio frequency transceiver (RFT) 12, a controller 13, a memory 14 storing an ID and other information, a power unit 15, and an antenna 16. The OFR 11, RFT 12, memory 14 and power unit 15 are implemented in a single integrated circuit (IC). The OFR 11, RFT 12, memory 14 and power unit 15 are connected electrically to the control unit 13.

The OFR 11 includes a light receiving portion 11a. The light receiving portion 11a includes a light sensitive element such as a photodiode or a phototransistor. The OFR 11 supplies a signal demodulated from the command light CL when the command light CL is received by the light receiving portion 11a. The command light CL is a light with specific frequency and modulation, which are predetermined. The frequency can be visible light or infrared in order to configure the light receiving portion inexpensively. The modulation can be amplitude modulation (AM) or others such as frequency modulation (FM).

The input light can be thresholded to enable stable optical communication. Before the optical communication, the luminance threshold is initialized. Thus, stable optical communication is possible even when the ambient light or the command light varies in intensity.

The controller portion 13 includes a determining portion 13a for a determination process, a memory access portion 13b for a memory access process, an ID transmitting portion 13c for an ID transmission process and a register 13d.

The determining portion 13a compares the luminance signal from the OFR 11 with the luminance threshold value stored in the register 13a. When the luminance is in a one state, that is, the ID tag 10 is illuminated by the reader 20, the determining portion 13a causes the memory access portion 13b to read the ID in response to an ID read command from the RFT 12. Then, the memory access portion 13b supplies an ID read signal to the memory 14. In other words, the controller 13 asserts the ID read signal only when it is verified that the receiving light corresponds to the command light CL.

The memory 14 stores the ID related information. The ID related information includes tag specific identification; other attributes as described above; and control information, for example, a bit to command the tag to ‘sleep’, an error detection code such as CRC, and general information defined by the user. The controller 13 transfers the ID information to the RFT 12.

The RFT 12 includes an RF demodulation portion 12a and an RF modulation portion 12b. The RF demodulation portion 12a demodulates the ID read command transmitted from the reader 20 using radio waves of a predetermined frequency. The demodulated command is sent to the controller 13. The ID transmitting portion 13c of the controller 13 receives the ID related information from the memory and transfers the ID related information to the RFT 12. Based on the ID related information, the RF modulation portion 12b transmits the response signal via the antenna 16.

Usually, RFID uses frequency bands such as 125 kHz (low-frequency), 13.56 MHz (high-frequency), 860-960 MHz (ultra-high-frequency), 2.45 GHz (microwave) and so on.

The antenna 16 includes an induction coil, for example, at relatively low frequencies such as LF and HF, and the RF communication and power transmission is done by inductive coupling with the antenna of the reader 20.

In another instance using relatively high frequency, such as UHF and microwave, the antenna 16 includes a dipole antenna or a patch antenna to transmit and receive radio waves.

The power portion 15 includes a rectifier, a capacitor, and a reset controller. The rectifier rectifies power received by the antenna 16. The rectified power is stored in the capacitor and supplied to the tag 10. Thus, the tag 10 can operate without battery. The reset controller monitors the electric power stored in the capacitor and enables operation of the ID tag 10 only when sufficient power is stored.

As described above, the tag 10 transmits the response signal RS including the ID related information in response to receiving the command light CL.

Reader

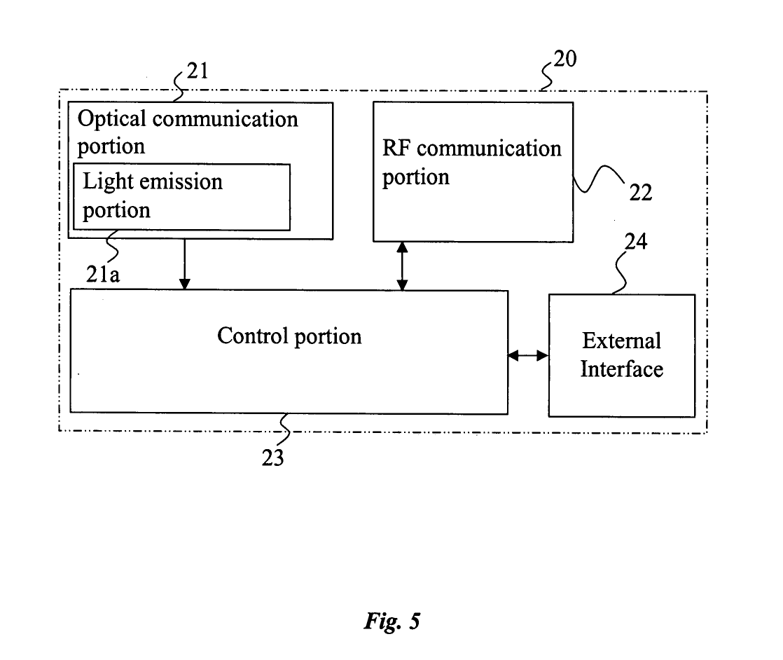

FIG. 5 show the reader 20 including an optical communication portion 21, an RF communication portion 22, a controller 23 and an external interface 24. The reader 20 causes the optical communication portion 21 to emit the command light CL based on a command received from the external interface 24, and causes the RF communication portion 22 to transmit the radio waves for the power supply of the reader and the ID read command. In response, the reader 20 receives the response signal RS transmitted from the ID tag 10 in the RF communication portion 22.

The optical communication portion 21 includes a light emission portion 21a. The light emission portion 21a includes a photo emitter, such as an LED, electric bulb, digital projector, and the like. The optical communication portion 21 emits the command light CL having a predetermined shape from the light emission portion 21a at a predetermined range and frequency. Therefore, the number of tags illuminated can be strictly controlled.

In response to receiving a start command from the controller 23, the RF communication portion 22 transmits the RF signal for the power supply of the tag. The RF communication portion 22 also receives the transmitted response signal RS, extracts the ID related information by demodulating the response signal RS, and then supplies the demodulated signal to the controller 23.

The controller 23 controls the optical communication portion 21 and the RF communication portion 22. More detailed, the controller 23 controls the RF communication portion 22 in response to receiving the read start signal from the external interface 24 and makes the RF communication portion 22 radiate the power supply electromagnetic wave and the read command. The controller 23 controls the optical communication portion 21 in response to receiving the read start signal from the external interface 24 and makes the light emission portion 21a emit the command light CL.

The external interface 24 is used for operations including sending commands to the reader 20 and outputting the result. As stationary RFID readers are usually configured, the external interface 24 can include communication portions such as Ethernet, wireless LAN, RS-232C and USB, and a communication processing portion such as a microprocessor to implement communication protocols for exchanging commands and data. The read start command signal is provided by the external interface 24 to the controller 23. The external interface can be connected to another computer or a user interface with control buttons. The external interface can also include a display unit.

RFID Operation

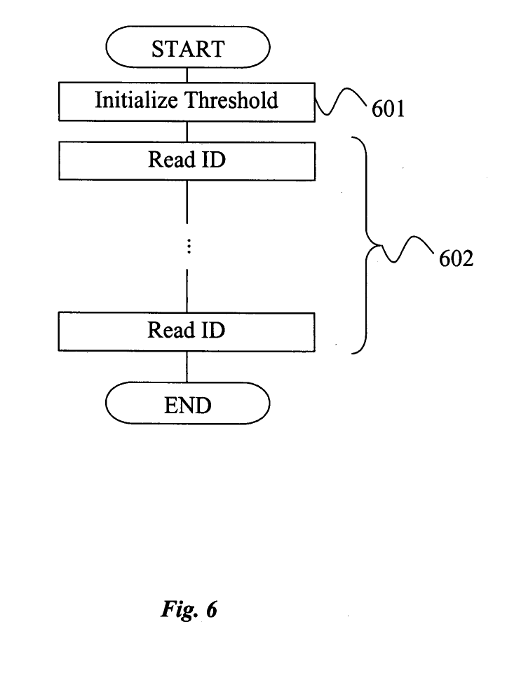

FIG. 6 shows the operation of the RFID system. A reading operation of the ID related information is started by a read start command given to the reader 20 through the external interface 24.

First, the luminance threshold of the OFR 11 is initialized 601. Next, one or more read operation 602 are performed.

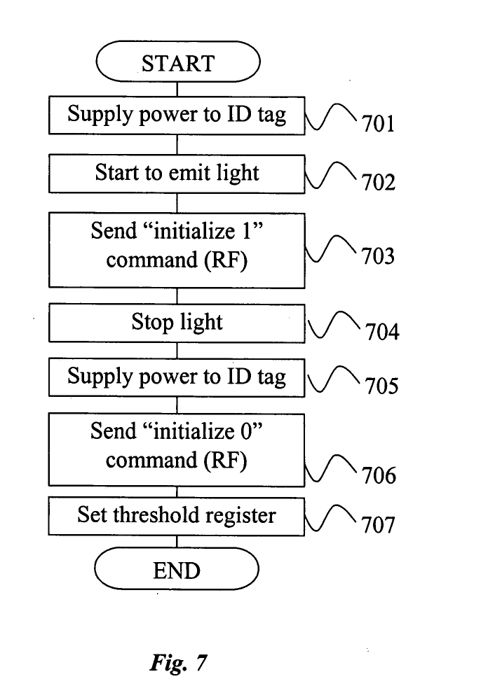

FIG. 7 shows the steps of initializing. First, the reader 20 transmits 701 the power supply electromagnetic waves from the RF communication portion 22, and the ID tag 10 stores power in the capacitor of the power portion 15 and supplies the power to each component of the tag 10. At the same time, the reader 20 emits 702 the light from the optical communication portion 21.

Then, the reader 20 transmits 703 the “initialize 1” command from the RF communication portion 22, and the tag 10 saves the luminance value when receiving the “initialize 1” command. After that, the reader 20: stops 704 emitting the light from the optical communication portion 21, radiates 705 the power supply electromagnetic waves, and sends 706 the “initialize 0” command. The ID tag 10 saves the luminance value when receiving the “initialize 0” command, stores 707 an intermediate value between the luminance values of “initialize 1” and “initialize 0” to the register 13d as the luminance threshold.

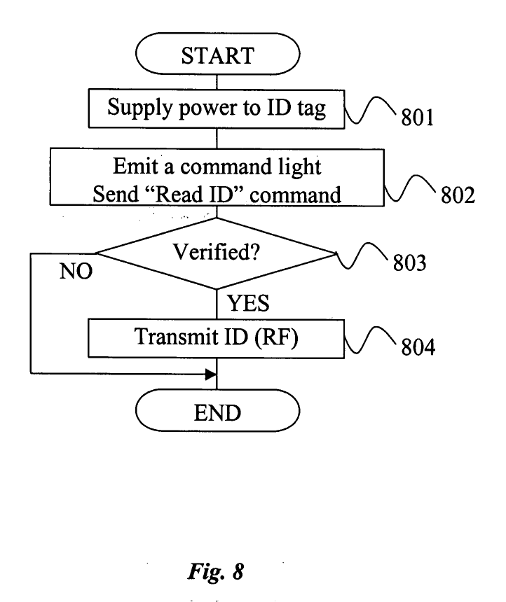

FIG. 8 shows the operation of the “read ID” command of FIG. 6. First, the reader 20 radiates the power supply electromagnetic waves from the RF communication portion 22. Then the ID tag 10 stores power at the capacitor of the power portion 15 and supplies 801 the power to each component of the ID tag 10. Then the reader 20 emits the command light CL at the predetermined range, and synchronously, radiates 802 the “read ID” command from the RF communication portion 22. After verifying 803 that the command light CL has been received, the ID tag 10 transmits 804 the response signal including the ID related information to the reader 20.

Specifically, the tag 10 determines whether or not the received light is the command light CL by comparing the intensity of the received light in the OFR 11 with the luminance threshold value stored in the register 13d. When it is verified that the received light is the command light CL, then the controller 13 supplies the ID read signal to the memory 14 and reads out the ID related information from the memory 14. The ID related information, which is read out, is transmitted 804 from RFT 12 as the response signal.

The reader 20 extracts the ID related information from the response signal received at the RF communication portion 22. The extracted ID related information can be stored to the memory of the reader 20. The information can also be displayed and transmitted to another computer.

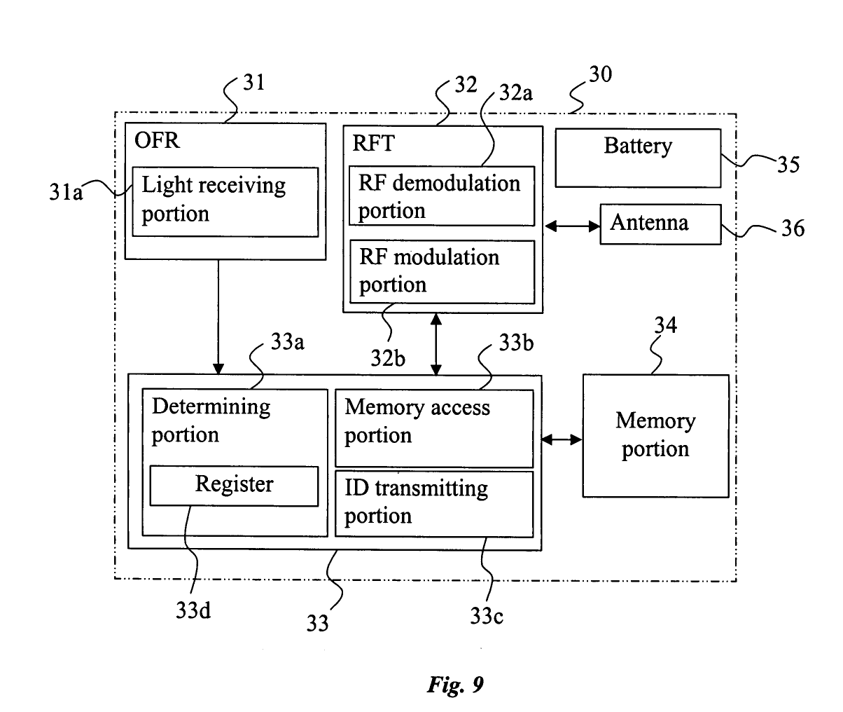

FIG. 9 shows an alternative embodiment 30 of the tag 10. The tag has an optical frequency receiver (OFR) 31 including a light receiving portion 31a; a radio frequency receiver (RFT) 32 with a RF demodulation portion 32a and a RF modulated portion 32b; a controller 33 having a determining portion 33a, a memory access portion 33b, an ID transmitting portion 33c and a register 33d; a memory 34, an antenna 36, and a battery 35. The battery 35 supplies electric power to each portion in ID tag 30.

The battery can extend the transmission range of the tag and the reader does not need to supply power.

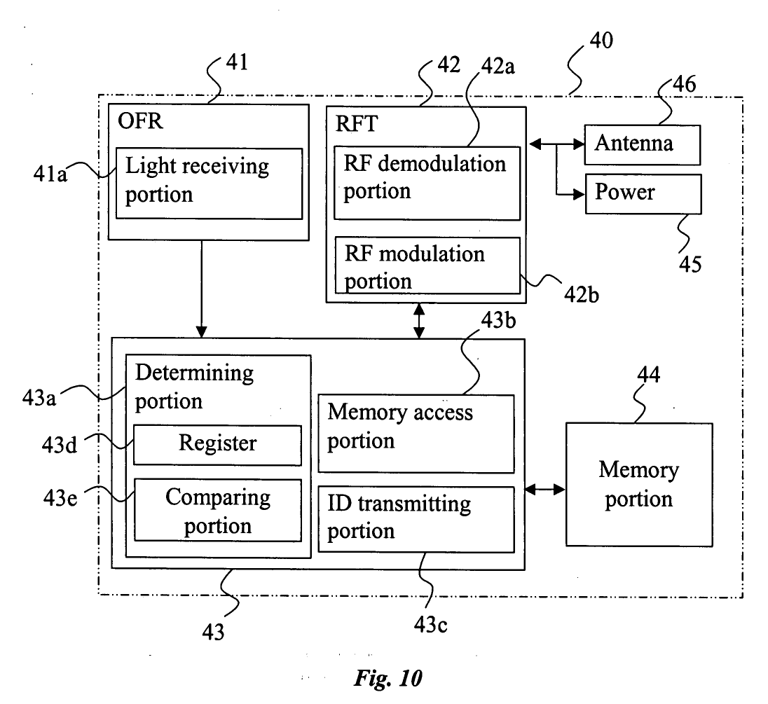

Another embodiment 40 of the reader is shown in FIG. 10. The tag has an optical frequency receiver (OFR) 41 including a light receiving portion 41a; a radio frequency receiver (RFT) 42 with a RF demodulation portion 42a and a RF modulated portion 42b; a controller 43 having a determining portion 43a, a memory access portion 43b, an ID transmitting portion 43c, a register 43d, and a comparing portion 43e; a memory 44, an antenna 46, and a power portion 45. The power portion 45 supplies electric power to each portion in ID tag 40.

The ID tag 40 determines whether or not the command light CL is received according to a modulated pattern of received light. In other words, the command light CL has multiple ‘bits’. The modulation pattern can use the well known Gray code. More specifically, a determining portion 43a includes a register 43d and a comparing portion 43e. The register 43d stores predetermined binary code in predetermined number of bits. The register 43d can also be implemented as a electronically rewritable memory such as EEPROM. The comparing portion 43e compares the demodulated signal output from a light receiving portion 41a in a OFR 41 with the code stored in the register 43d. If the two are identical, then the ID read signal is supplied to a memory access portion 43b.

As a result, the memory access portion 43b reads the ID related information from a memory 44, and a ID transmitting portion 43c supplies the information to a RFT 42. The RFT 42 generates the response signal including the ID related information to the RF modulation portion 42b and transmits the response signal via the antenna 46.

As described above, the code is extracted from the received signal by the light receiving portion 41a of the OFR 41, and the ID related information is transmitted only when the extracted code corresponds to the stored contents in register 43d. Consequently, the accuracy of the ID verification is improved.

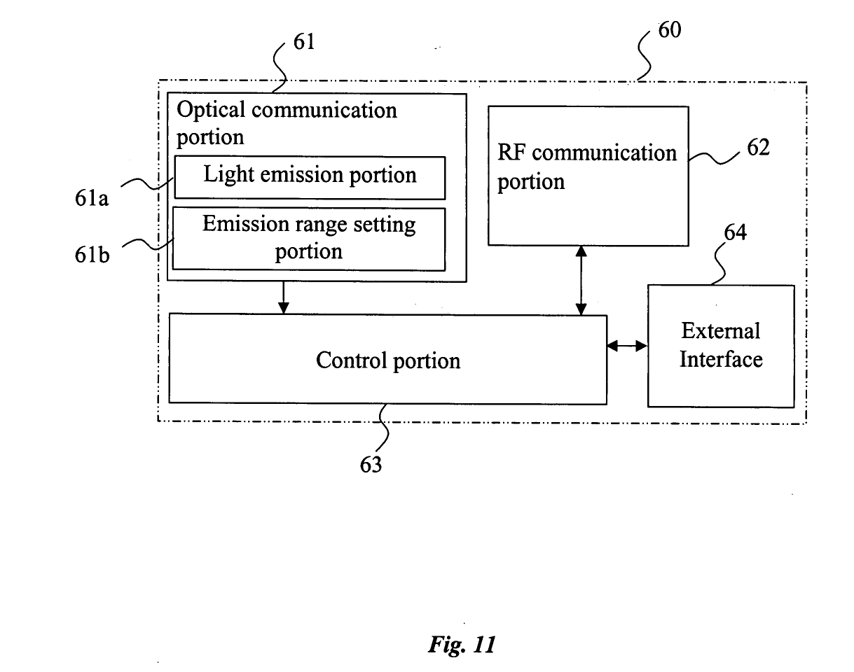

FIG. 11 shows an alternative embodiment 60 of a reader 20. In this embodiment, the emission range of the command light CL can be varied by the reader 60.

The optical communication portion 61 in the reader 60 has an emission range setting portion 61b in addition to a light emission portion 61a. The emission range setting portion 61b changes the emission range according to a control signal generated by the controller 63. The controller 63 controls the emission range setting portion 61b based on an instruction signal from the external interface 64. More detailed, the external interface 64 provides the command to start reading and a command to set the emission range. The controller 63 controls the emission range setting portion 61b so that the light is emitted at a range corresponding to the command to set the emission range. The function of the RF communication portion 62 is as described above.

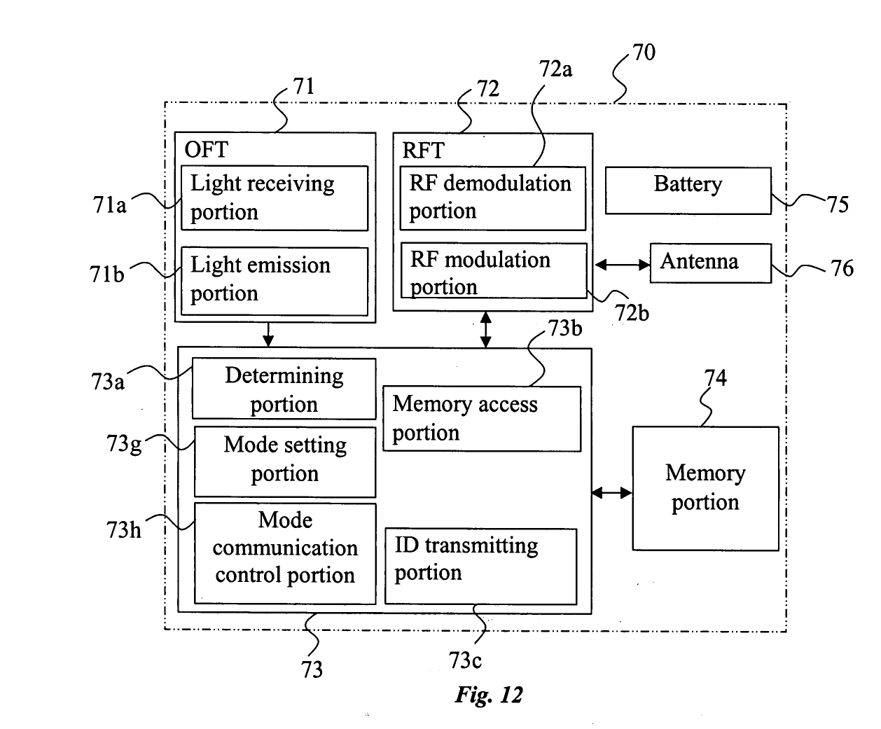

FIG. 12 shows an alternative embodiment 70 of a ID tag 10. The ID tag 70 includes an optical frequency transceiver (OFT) 71 having a light emission portion 71b in addition to a light receiving portion 71a. The ID tag 70 can set a transmit and a receive mode for both the OFT 71 and the RFT 72, and transmits the responding signal from the transceiver being operated in the transmit mode in response to receiving a predetermined signal at the transceiver being operated in the receive mode. This ID tag 70 is an example of an active tag.

In more detail, the ID tag 70 includes the OFT 71, the RFT 72 having an RF demodulation portion 72a and an RF modulation portion 72b, a controller 73, a memory 74, a battery 75 and an antenna 76.

The OFT 71 includes a light receiving portion 71a and a light emission portion 71b and can receive and emit light at predetermined frequencies. The light receiving portion 71a includes a photodiode or phototransistor for example, and the light emission portion 71b includes an LED, for example. Both the light receiving portion 71a and the light emission portion 71b can be implemented with a single LED as described in U.S. Patent Application Ser. No. 10/126,761, “Communication Using Bi-Directional LEDs,” filed by Dietz et al. on Apr. 19, 2002 incorporated herein by reference in its entirety.

The OFT 71, the RFT 72, the controller 73 and the memory 74 can be implemented in a single integrated circuit (IC) to reduce cost, but this is not necessary for implementation.

The controller 73 in the ID tag 70 includes a mode setting portion 73g and a mode communication controller 73h in addition to a determining portion 73a, a memory access portion 73b and an ID transmitting portion 73c. The mode setting portion 73g sets up one of a transmitting and receiving mode to one of two transceivers and the other mode to the other transceiver. The mode setting portion 73g sets up a transmitting/receiving mode to one of two transceivers and transmitting or receiving mode to the other transceiver. This mode setting process is conducted in response to the mode setting signal transmitted from the reader 80 and is implemented as switching or software in controller 73.

The possible setting pattern is as follows: (a) receiving mode to OFT and transmitting mode to RFT, transmitting mode to OFT and receiving mode to RFT, (c) transmitting/receiving mode to OFT and transmitting mode to RFT,
(d) transmitting mode to OFT and transmitting/receiving mode to RFT, and (e) transmitting/receiving mode to OFT and transmitting/receiving mode to RFT.

The mode communication controller 73h controls the transceiver being operated in the transmitting mode so as to transmit the ID related information as the response signal, in response to receiving the command signal at the transceiver being operated in the receiving mode. The mode communication controller 73h controls the OFT 71 so as to emit light in a case where the mode (c) or (e) is used.

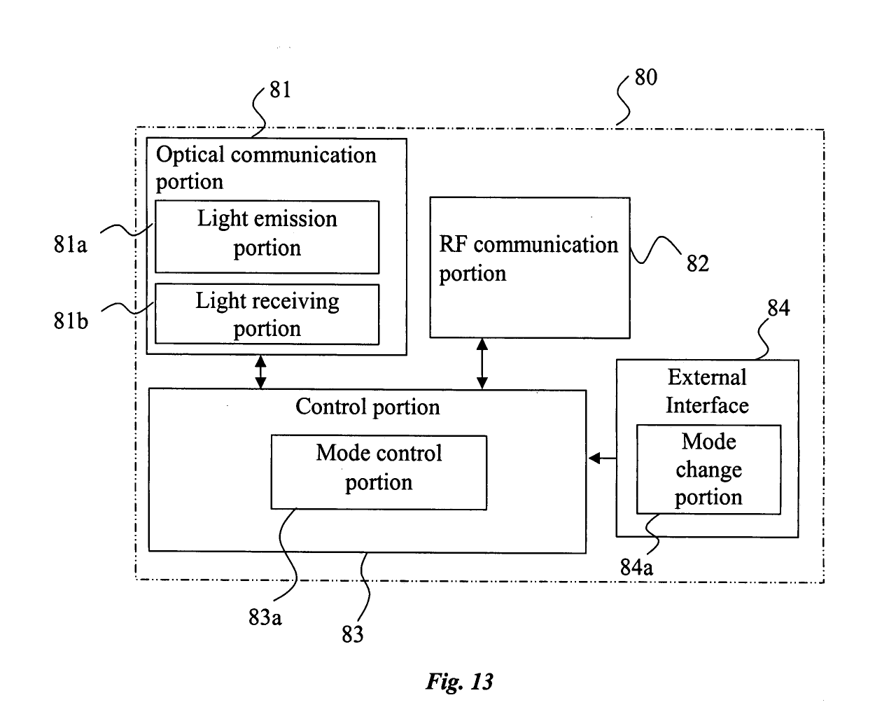

FIG. 13 is a block diagram of an alternative reader 80. The reader 80 includes an optical communication portion 81, an RF communication portion 82, a controller 83 and an external interface 84. The external interface 84 can be implemented as described above, and can also include a mode change portion 84a. The mode change portion 84a is for changing the transmitting/receiving mode, as controlled by an external communication protocol or a mode change key in an interactive interface.

The controller 83 includes a mode controller 83a. The mode controller 83a controls the optical communication portion 81 and the RF communication portion 82 so as to be operated in the mode instructed by the mode change portion 84a in the external interface 84. The controller 83 also generates a mode setting signal so as to make the ID tag 70 operate in the same mode as that instructed by the mode change portion 84a and transmits the mode setting signal from the RF communication portion 82 to the ID tag 70. As described above, the ID tag 70 sets up a mode instructed by the mode setting signal.

The optical communication portion 81 in the reader 80 includes a light emission portion 81a and a light receiving portion 81b. The light receiving portion 81b receives the light emitted from the ID tag 70 as a response signal including the ID related information.

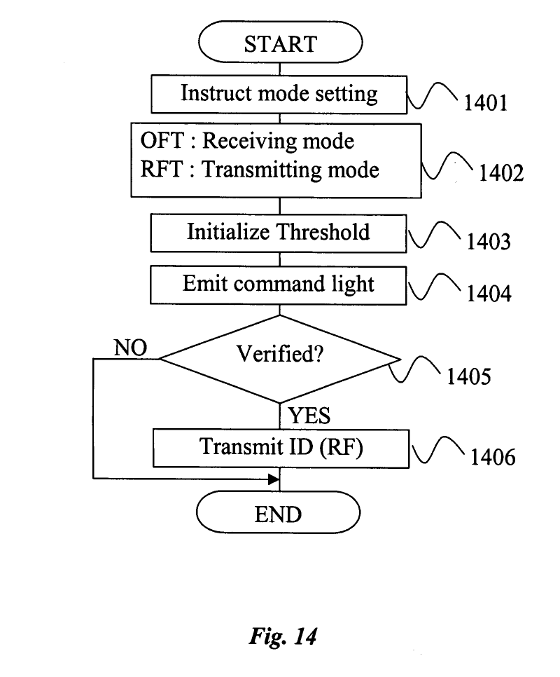

FIG. 14 shows the operation of the reader of the above embodiment. For example, the reader 80 transmits 1401 the mode setting signal instructing the mode pattern (a) to the ID tag 70. The ID tag 70 sets up 1402 the receiving mode to the OFT 71 and the transmitting mode to the RFT 72. More detailed, the RFT 72 in the ID tag 70 supplies the mode setting signal to the controller 73 when receiving the mode setting signal. The mode setting portion 73g in the controller 73 sets up the receiving mode to the OFT 71 and the transmitting mode to the RFT 72 based on the instruction of the mode setting signal.

When the reader 80 receives the command to start reading through the external interface 84, the reader executes 1403 the “initialize threshold” process. Then, the reader 80 modulates the light based on the predetermined code and emits 1404 the modulated light toward the predetermined range as a command light CL.

When the ID tag 70 within the emission range verifies 1405 that the received light is the command light CL, the tag transmits 1406 the response signal RS including the ID related information. More detailed, because the transmitting mode is set up to the RFT 72, the controller 73 reads out the ID related information from the memory 74 in response to receiving the command light at the OFT 71 and supplies the information to the RFT 72. The RFT 72 generates the response signal having the ID related information and transmits the information by radio frequency. The RF communication portion 82 in the reader 80 extracts the ID related information from the received response signal.

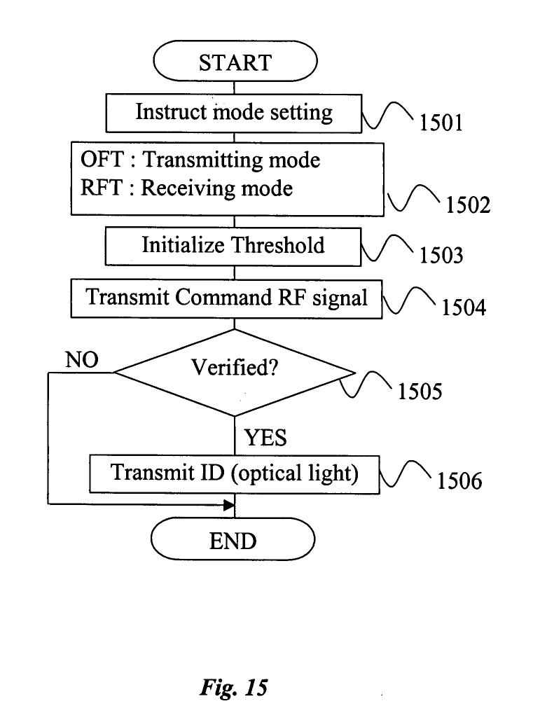

FIG. 15 shows the operation of the RFID of the above embodiment for an alternative mode set up. The controller 83 in the reader 80 sets up the mode pattern (b) based on the instruction from the external interface 84. The controller 83 makes the RF communication portion 82 transmit 1501 the mode setting signal instructing to set up the mode pattern (b) to the ID tag 70. As a result, the ID tag 70 sets up 1502 the transmitting mode to the OFT 71 and the receiving mode to the RFT 72.

When the reader 80 receives the command to start reading through the external interface 84, the reader executes 1503 the “initialize threshold” process. In this case, the ID tag 70 emits light and the reader 80 receives light, and therefore, the threshold initialization is done in the reader 80. Then, the reader 80 generates the command RF signal having the predetermined command and transmits 1504 the command via the RF communication portion 82.

When the command RF signal is received at RFT 72, the controller 73 in the ID tag 70, verifies 1505 that the receive signal is the command RF signal and transmits 1506 the response signal having the ID related information to the reader 80. More detailed, because the transmitting mode is set up for the OFT 71, the controller 73 generates a light signal having the ID related information read out from the memory 74 as the response signal and makes the OFT 71 transmit the response signal. When the response signal is received at the optical communication portion 81 in the reader 80, the controller 83 extracts the ID related information from the response signal.

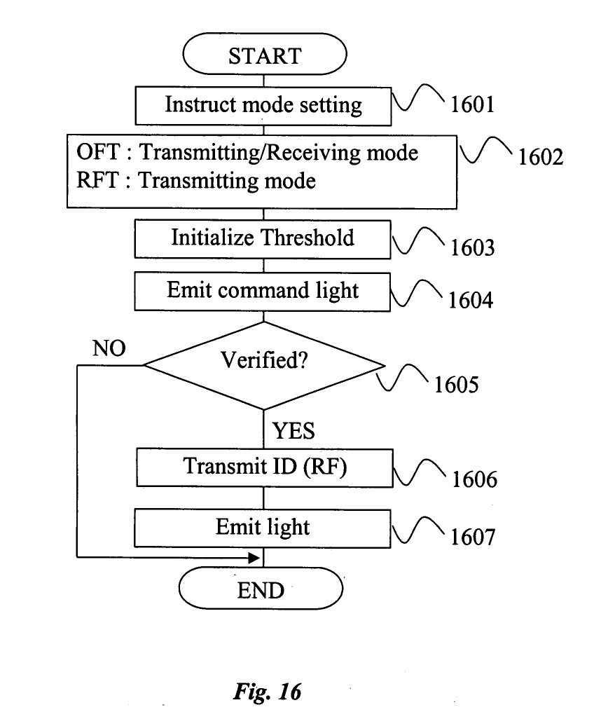

FIG. 16 is a flowchart showing an operation of the RFID for setting up mode pattern (c). The controller 83 in the reader 80 sets up the mode pattern (c) based on the instruction from the external interface 84. The controller 83 makes the RF communication portion 82 transmit 1601 the mode setting signal instructing the set up mode pattern (c) in the ID tag 70. The ID tag 70 sets up 1602 the transmitting/receiving mode for the OFT 71 and the transmitting mode for the RFT 72.

When the reader 80 receives the command to start reading through the external interface 84, the reader executes 1603 the “initialize threshold” process. The reader 80 generates the command light CL and emits 1604 the CL toward the RFID at the predetermined range.

When it is verified 1605 that the received light is the command light CL, the ID tag 70 transmits 1606 the response signal having the ID related information to the reader 80. More detailed, because the transmitting mode is set up to the RFT 72, the controller 73 generates the RF signal having the ID related information read out from the memory 74 as the response signal and makes the RFT 72 transmit the signal. When the response signal is received at the RF communication portion 82 in the reader 80, the controller 83 extracts the ID related information from the response signal.

The ID tag 70 also sets up the transmitting mode to the OFT 71. When it is verified 1605 the received light is the command light CL, the controller 73 in ID tag 70 makes the emission portion 71b in the OFT 71 emit 1607 light. Therefore, user can see the light emitted from the ID tag 70 and thus can recognize the location of the ID tag 70.

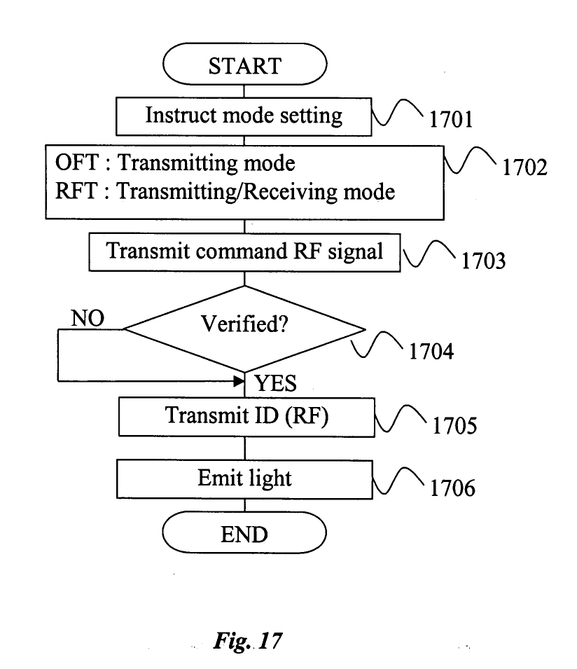

FIG. 17 shows the operation of the RFID for mode pattern (d) set up. The reader 80 sets up each component for the mode pattern (d) based on the instruction from the external interface 84. The reader 80 makes the RF communication portion 82 transmit 1701 the mode setting signal instructing the tag to set up the mode pattern (d) in the ID tag 70. As a result, the ID tag 70 sets up 1702 the transmitting mode to the OFT 71 and the transmitting/receiving mode to the RFT 72 based on the mode setting signal.

When the reader 80 receives the command to start reading through the external interface 84, the reader generates the command RF signal and makes the RF communication portion 82 transmit 1703 the signal.

When it is verified 1704 that the received RF signal is the command RF signal, the ID tag 70 transmits 1705 the response signal having the ID related information to the reader 80. More detailed, because the transmitting mode is set up to the RFT 72, the controller 73 generates the RF signal having the ID related information read out from the memory 74 as the response signal and makes the RFT 72 transmit the signal. When the response signal is received at the RF communication portion 82 in the reader 80, the controller 83 extracts the ID related information from the response signal.

In addition, the ID tag 70 also sets up the transmitting mode to the OFT 71. When it is verified that the received RF signal is the command RF signal, the controller 73 in ID tag 70 makes the light emission portion 71b in the OFT 71 emit 1706 light. Therefore, the user can see the light emitted from the ID tag 70 and thus can recognize the location of the ID tag 70.

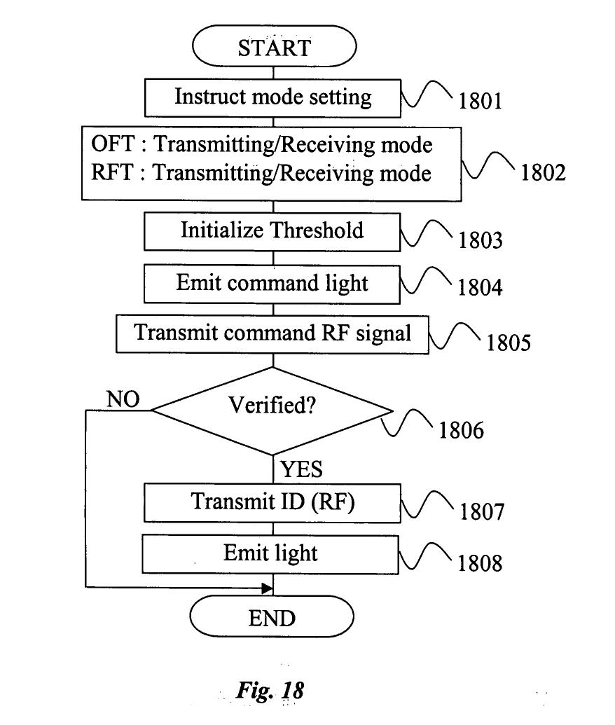

FIG. 18 shows the operation of the RFID for mode pattern (e) set up. The reader 80 sets up each component so as to activate the mode pattern (e) based on the instruction from the external interface 84. The reader 80 makes the RF communication portion 82 transmit 1801 the mode setting signal instructing the set up of the mode pattern (e) to the ID tag 70. As a result, the ID tag 70 sets up 1802 the transmitting/receiving mode to both the OFT 71 and RFT 72 based on the mode setting signal.

When the reader 80 receives the command to start reading through the external interface 84, the reader executes 1803 the “initialize threshold” process. Then, the reader 80 generates both the command light CL and command RF signal and makes the optical communication portion 81 and the RF communication portion 82 transmit them, respectively steps 1804 and 1805.

When the tag verifies 1806 that the received light and RF signal are the command light and the command RF signal, the ID tag 70 transmits 1807 the response signal having the ID related information to the reader 80.

More detailed, when the luminance of the received light is equal or more than the luminance threshold value and the predetermined command is included in the received radio wave, the controller 73 generates the RF signal having the ID related information read out from the memory 74 and makes the RFT 72 transmit the information. When the response signal is received at the RF communication portion 82 in the reader 80, the controller 83 extracts the ID related information from the response signal.

In addition, the ID tag 70 also sets up the transmitting mode to the OFT 71. When the command light and the command RF signal is verified, the controller 73 in ID tag 70 makes the light emission portion 71b in the OFT 71 emit 1808 light. Therefore, the user can see the light emitted from the ID tag 70 and thus can recognize the position of the ID tag 70.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. An identification tag comprising:
a memory storing an identification code;
an optical communication portion configured to receive a predetermined optical signal; and
a radio communication portion configured to transmit the identification code stored in the memory when receiving the predetermined optical signal by the optical communication portion.

2. The identification tag of claim 1, wherein the optical communication portion transmits an optical signal, the radio communication portion receives a radio signal, and further comprising:
means for operating at least one of the communication portions in receive mode while operating at least one of the communication portions in transmit mode; and
means for transmitting the identification code by the communication portions operating in the transmit mode in response to receiving a predetermined signal by the communication portions operating in the receive mode.

3. An identification method, comprising:
receiving a predetermined optical signal at an optical communication portion in an identification tag; and
transmitting an identification code stored in memory by a radio communication portion when receiving the predetermined optical signal by the optical communication portion.

4. The identification method of claim 4, further comprising:
operating at least one of the communication portions in receive mode while operating at least one of the communication portions in transmit mode; and
transmitting the identification code by the communication portions operating in the transmit mode in response to receiving a predetermined signal by the communication portions operating in the receive mode.

5. An identification reader, comprising:
an optical communication portion transmitting a predetermined optical signal; and
a radio communication portion receiving an identification code transmitted when receiving the predetermined optical signal by an identification tag.

6. The identification tag of claim 1, wherein the predetermined optical signal has a predetermined level.

7. The identification tag of claim 6 further comprising:
a determining portion for determining whether the received optical signal is the predetermined optical signal based on a level of the received optical signal; and
wherein the radio communication portion transmits the identification code based on the determination by the determination portion.

8. An identification tag of claim 1, wherein the predetermined optical signal is modulated by a predetermined Gray code.

9. The identification tag of claim 8 further comprising:
a determining portion for determining whether the received optical signal is the predetermined optical signal based on a Gray code demodulated from the received optical signal; and
a radio communication portion transmitting the identification code based on the determination by the determination portion.

10. The identification tag of claim 1, wherein the radio communication portion receives a command radio frequency signal and the optical communication portion transmits an identification code stored in the memory when receiving the command radio frequency signal by the radio communication portion.
